(19) United States
(12) Patent Application Publication
(10) Pub. No.: US 2002/0021304 A1
(43) Pub. Date: Feb. 21, 2002

(54) Image processing system for adding add information to image object, image processing method and medium

(76) Inventor: Harutaka Eguchi, Kawasaki (JP)

Correspondence Address: STAAS & HALSEY LLP, 700 11TH STREET, NW, SUITE 500, WASHINGTON, DC, 20001, US

(21) Appl. No.: 09/783,558

(22) Filed: Feb. 15, 2001

(30) Foreign Application Priority Data
Aug. 18, 2000 (JP) 2000-248236

(51) Int. Cl. G09G 5/00

(52) U.S. Cl. 345/629

(57) ABSTRACT

An image processing technology is capable of saving an image object with add information to manage the image object with the same feeling as a photo in a normal photo album. An image processing system comprises a control unit for having an image object specified as a processing target and having the add information specified that decorates the image object. The control unit adds, to the image object, the add information treatable as an integral component with the image object in a state that does not alter a content of the image object itself.

### BACKGROUND OF THE INVENTION

The present invention relates to a technology of adding information to an image file.

It has been daily conducted over the recent years that an Internet user downloads a file recorded with an image object such as a photo etc (which will hereinafter be called an image file) and stores the file in a terminal device. Further, it has also been daily conducted that the image file of the photo taken by a digital camera is stored in the image processing system such as a personal computer etc.

The JPEG format is one of image file formats. The JPEG format is widely used for recording the image on the computer.

By the way, a printed photo is generally saved by pasting it to a photo album or filing it or stocking it into a pocket. In this case, a tag described with add information on the photo such as a photographing date, a photographing location and a photographing situation (e.g., a name of event like an excursion, a travel, an athletic meet etc), might be pasted in the vicinity of the photo. Further, this kind of add information might be written in a blank of the photo album stuck with the photo.

Therefore, a user who saves the photo in the JPEG file has a desire for storing the add information together with the photo as in the case of saving the photo in the album.

According to the format of the JPEG file, however, there is only a definition about an internal area within an outer periphery of the image. Hence, in the JPEG file, a text as the add information can be pasted neither to the periphery of the photo image nor onto the image. Accordingly, the add information is stored as a file different from the JPEG file of the photo. Then, when displaying the text as the add information together with the photo image, the user must execute a display process using each individual file. This might require a time for displaying the photo.

Further, the JPEG file can be altered by use of processing software (drawing software) of the JPEG file. Namely, the add information can be added to the photo by writing the text onto the photo image.

In this case, however, contents themselves of the JPEG file change, and it is therefore difficult to delete or rewrite the text written onto the photo. Further, it is much harder to make the text revert to the state before being written. Accordingly, this method needs a measure of taking a backup for every photo.

### SUMMARY OF THE INVENTION

It is a primary object of the present invention, which was devised to obviate the problems inherent in the prior art, to provide a technology capable of saving an image object with add information in order to manage the image object with the same feeling as a photo in a normal photo album.

It is another object of the present invention a technology capable of adding, changing and deleting the add information with respect to the image object without altering the image object itself.

To accomplish the above objects, according to one aspect of the present invention, an image processing system comprises a control unit for having an image object specified as a processing target and having add information specified that decorates the image object. The control unit adds, to the image object, the add information treatable as an integral component with the image object in a state that does not alter a content of the image object itself.

Preferably, this control unit may have the add information specified, which is added to the image object, and may add the add information to the image object, the information being treatable as an integral component with the image object and removably addable in a state that does not alter the content of the image object itself. The state of being “removably addable” herein implies that, for example, the add information is possible of being added to and deleted from the image object, and the image object is not altered by such an addition or deletion.

The add information may be a frame removably addable to the image object. Herein, the state of being removably addable implies that, for example, after adding the frame to the image object, the frame is deleted, and the image object can be easily restored to the state before the addition of the frame.

The add information may configure a part of the image object in an added state.

The add information may have at least one of a sound attribute, a text attribute and a behavior attribute together with an image attribute for configuring a part of the image obj ect.

According to the present invention, the image attribute of the add information may be displayed, the sound attribute thereof may be reproduced, the text attribute thereof may be displayed, and the behavior attribute may be executed in linkage with an operation through the control unit.

According to the present invention, the image processing system may further comprise a recording unit for recording the add information as a single file together with the image object.

According to another aspect of the present invention, an image processing system for displaying an image object in a display area, comprises a unit for detecting the image object recorded in a file, and control data contained in the image object, and a unit for decorating the image object by use of add information indicated by the control data detected, and displaying the decorated image object in the display area.

According to a further aspect of the present invention, an image object processing method comprises a step of specifying an image object as a processing target, a step of specifying add information to be added to the image object, and a step of adding, to the image object, the add information treatable as an integral component with the image object in a state that does not alter a content of the image object itself.

According to the present invention, a program for actualizing any one of the functions described above may be recorded on a readable-by-computer recording medium.

According to a still further aspect of the present invention, a readable-by-computer recording medium recorded with an image object comprising visible data, and control data for the image object. The control data indicates add information for decorating the visible data, and is used when the visible data is displayed in a display area.

Herein, the visible data represents an original image of the image object to which the add information is added. Further, the control data is data, for indicating the add information based on a predetermined data format. The predetermined data format is, for instance, APPA (application marker) contained in JPEG formatted data.

As discussed above, according to the present invention, the add information related to the image can be embedded into the image file.

On this occasion, the add information relative to the image object can be added, changed and deleted without altering the image object itself.

### BRIEF DESCRIPTION OF THE DRAWINGS

FIG. 1 is an explanatory view showing a concept of an information add process;

FIG. 2 is a diagram showing frame types;

FIG. 3 is a diagram showing a frame action (static frame)

FIG. 4 is a diagram showing a frame action (frame scrolling);

FIG. 5 is a diagram showing a frame action (frame rotation);

FIG. 6 is a diagram showing a frame action (frame opening);

FIG. 7 is a diagram showing a frame action (frame emerging);

FIG. 8 is a diagram showing an outline of a data format of an APPA marker field;

FIG. 9 is a diagram showing a structure of a frame data field 40;

FIG. 10 is a diagram showing a structure of a frame add position specifying subfield 41;

FIG. 11 is a diagram showing details of a frame action specifying subfield 42;

FIG. 12 is a diagram showing a list of positions where the frame action can be specified;

FIG. 13 is a diagram showing a structure of a frame data specifying subfield 43;

FIG. 14 is a diagram showing details of frame data attribute information (text);

FIG. 15 is a diagram showing details of frame data attribute information (sound);

FIG. 16 is a diagram showing details of frame data attribute information (image);

FIG. 17 is a diagram showing a hardware architecture of an image processing system 1;

FIG. 18 is a diagram showing an operation screen for an information add process;

FIG. 19 is a diagram showing an example of a frame adding operation;

FIG. 20 is a flowchart showing a data coding process;

FIG. 21 is a flowchart showing an APPA marker writing process;

FIG. 22 is a flowchart showing a data decoding process;

FIG. 23 is a flowchart showing a marker analyzing process; and

FIG. 24 is a flowchart showing an APPA marker analyzing process.

### DETAILED DESCRIPTION OF THE PREFERRED EMBODIMENT

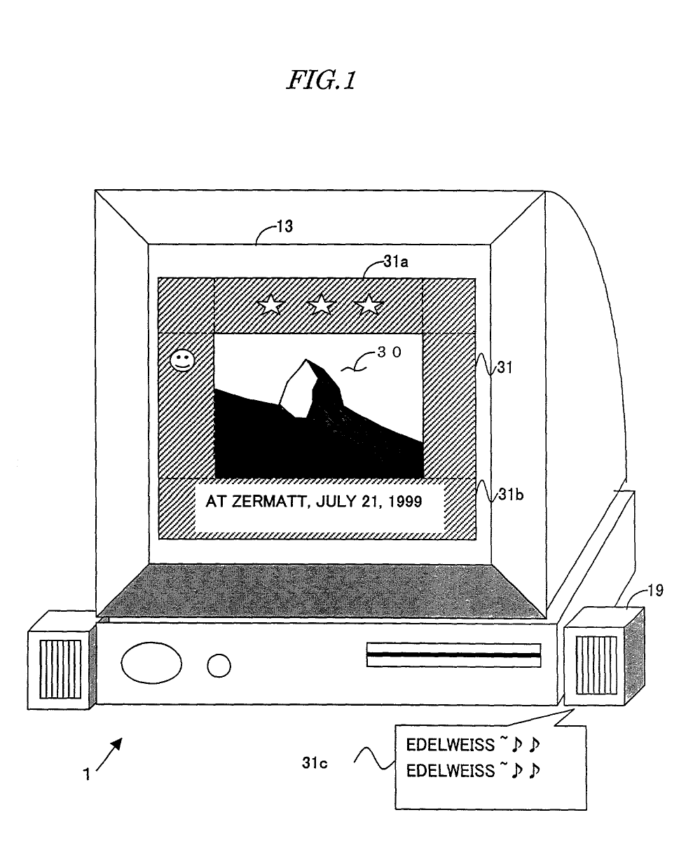

A preferred embodiment of the present invention will hereinafter be described with reference to FIGS. 1 through 24.

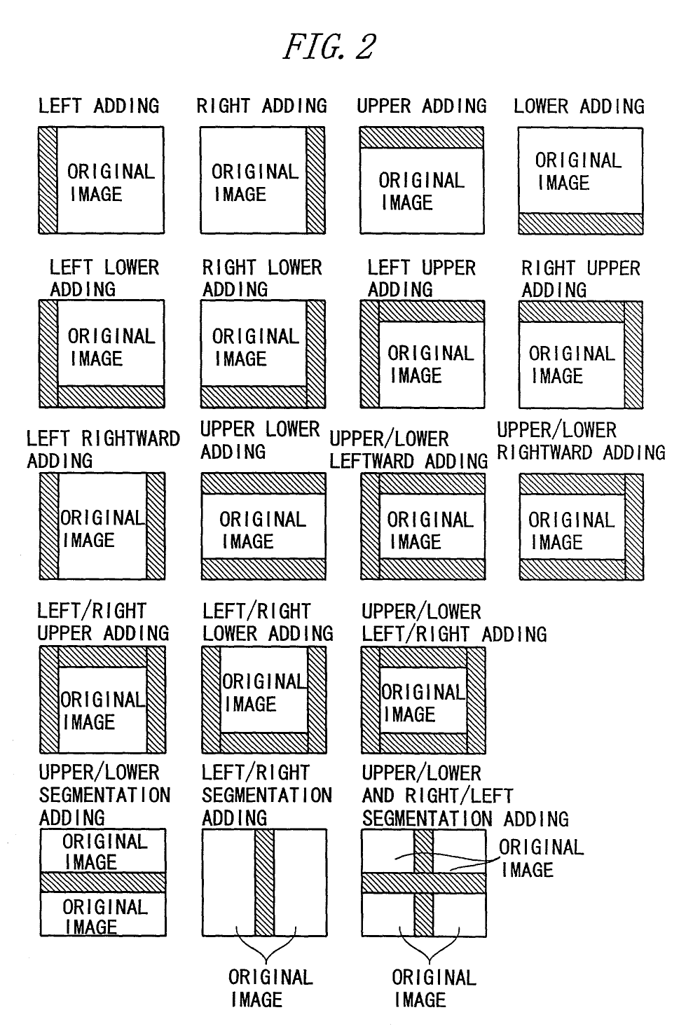

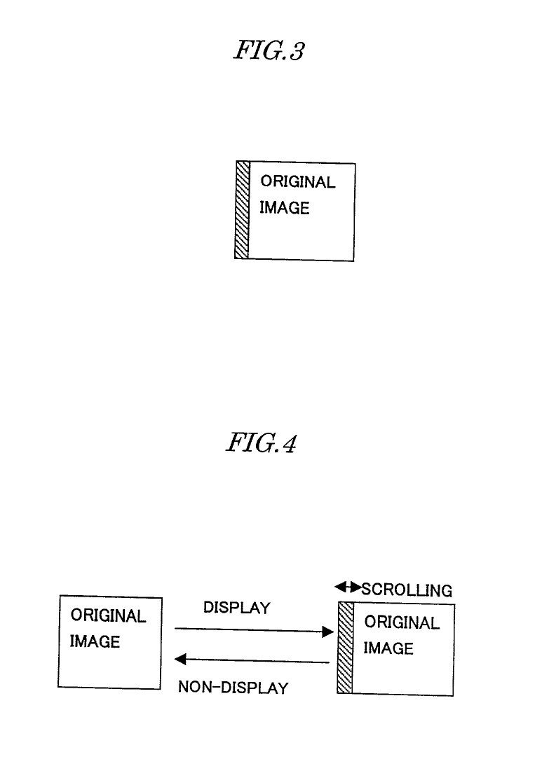

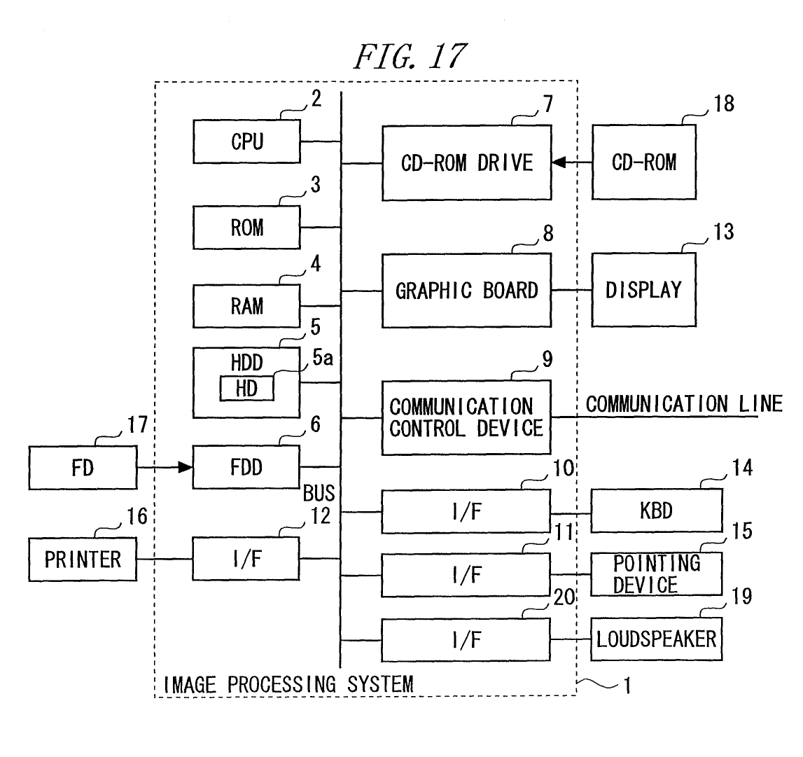

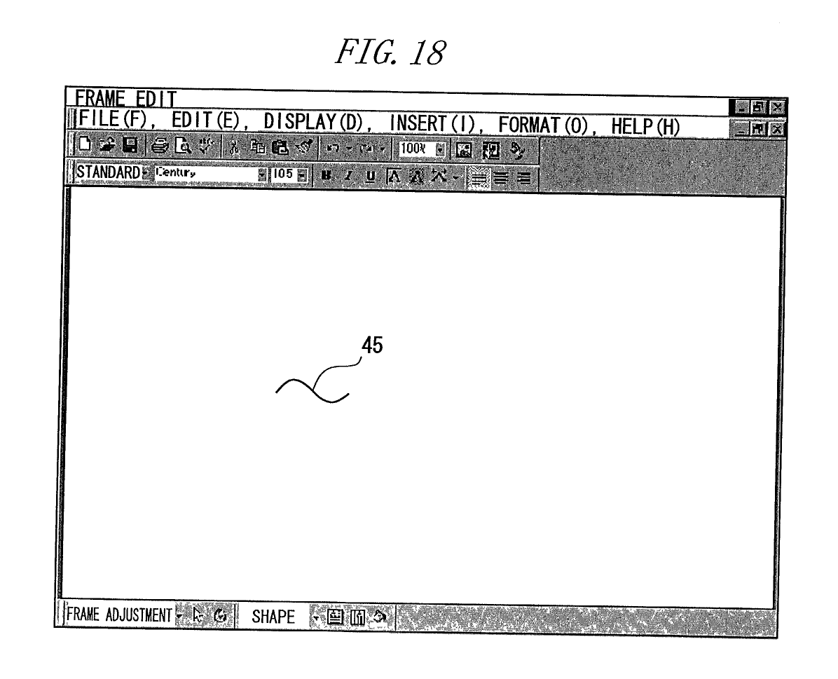

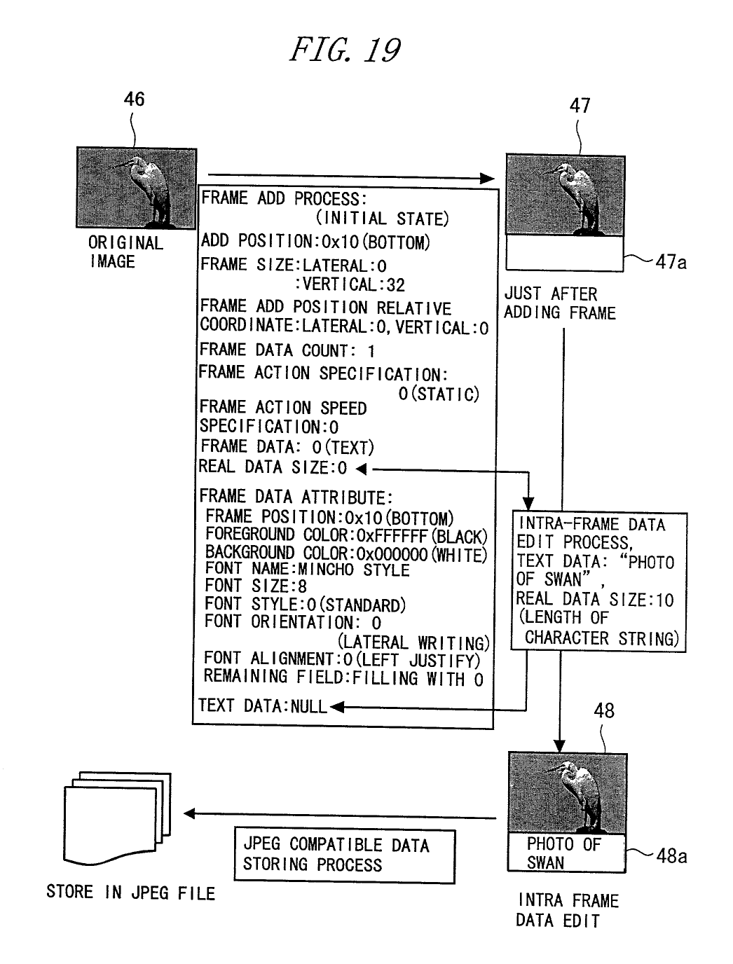

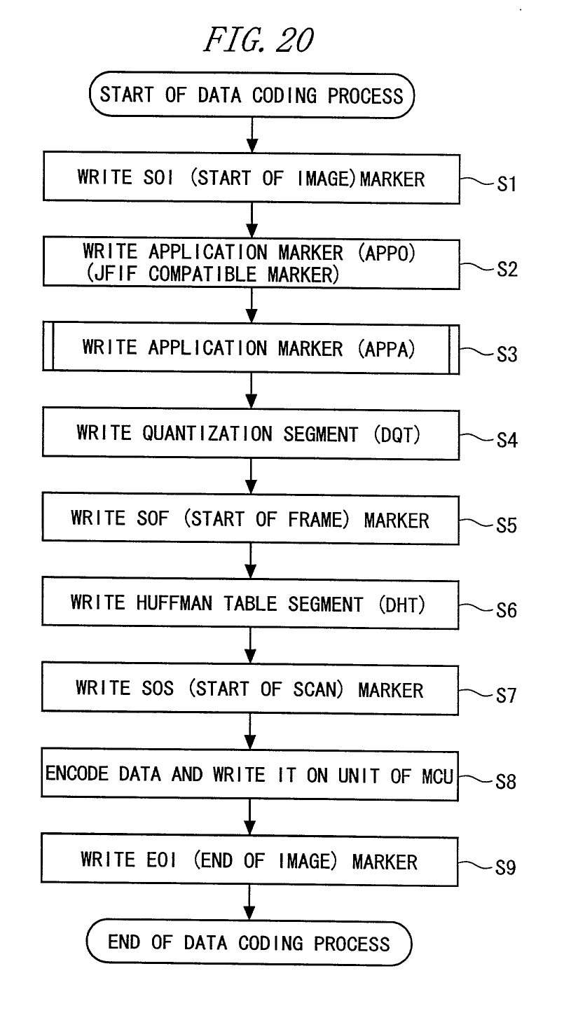

FIG. 1 is an explanatory view showing a concept of an information adding process executed by an image processing system 1 in this embodiment. FIG. 2 is a diagram showing frame types. FIGS. 3 through 7 are diagrams each showing a frame action. FIGS. 8 through 16 are diagrams each showing a data format of the information to be added. FIG. 17 is a diagram showing a hardware architecture of the image processing system 1. FIG. 18 is a view showing an operation screen for the information adding process. FIG. 19 is a diagram showing an example of a frame adding operation. FIGS. 20 to 24 are flowcharts showing processes of a program executed by a CPU 2 of the image processing system 1.

<Principle>

FIG. 1 is the explanatory view showing the concept according to the present invention. Referring to FIG. 1, an image object is displayed on a display 13 of the image processing system (personal computer) 1. This image object is composed of a one-frame image generated by a digital camera, and frames 31 (and 31a, 31b). Thus, the image processing system 1 provides a function of adding the frames 31 to the image object like the image 30.

The frame 31 among these frames is configured as a simple hatching area. On the other hand, images (three stars) each taking a star shape are added to the frame 31a. The three stars represent an impression of a photographer just when photographing the image. Thus, the image processing system 1 provides the function of adding other images to the image object by use of the frame area.

Further, a piece of text information [At Zermatt, Jul. 21, 1999] is added to the frame 31b. Thus, the image processing system 1 provides a function of adding the text information to the image object by use of the frame area.

Further, voices (singing “Edelweiss”) are outputted from a loudspeaker 19 connected to the image processing system 1, synchronizing with displaying the image object. The singing voices uttered from people around there when the image 30 was photographed. The singing voices were recorded together with the image by the digital camera. Thus, the image processing system 1 provides a function of adding the sound data related to the image object.

As discussed above, the image processing system 1 provides a function of storing batchwise pieces of information (the text, images and sounds) relative to the image object.

<Frame Types>

FIG. 2 shows type of the frames added to the image object by the image processing system 1 in this embodiment. The image processing system 1 adds one or more frames to arbitrary positions of the processing target image object (which will hereinafter be called an original image). The image processing system 1 prompts a user to specify the position to which the frame is added.

For example, when left adding, right adding, upper adding or lower adding is specified, the image processing system 1 adds the frame to the left side, light side, upper side or lower side of the original image.

As shown in FIG. 2, the frames may also be added by combining a plurality of add modes of left adding, right adding, upper adding and lower adding.

Further, the frame may also be added inwardly of the original image area. In this case, the original image is segmented by the added frame. A specification of segmenting the original image by one single frame into upper and lower areas, is termed “upper/lower segmentation adding”. Further, a combination of the upper/lower segmentation adding and right/left segmentation adding, is termed “right/left and upper/lower segmentation adding”.

<Categories of Frame Actions>

FIGS. 3 through 7 illustrate examples of the frame actions. The frame action may be defined as a behavior (action) attribute when the frame added to the original image is displayed on the image processing system 1.

FIG. 3 shows an example of a static frame. The static frame is classified as a motionless frame that is static to the original image. The static frame is, when the original image is displayed on the display 13, always displayed in a predetermined position of the original image. Referring to FIG. 3, an image and a text can be inserted in the static frame. For example, a text for explaining the original image, an image related to the original image and so on can be inserted.

Further, according to the image processing system 1, the related sound data can be embedded together with the static frame. Then, when displaying the original image attached with the static frame, the sound can be uttered synchronizing with this display.

FIG. 4 shows an example of frame scrolling. Frame scrolling may be defined as a behavior attribute in which a width of the frame is expanded stepwise to a predetermined dimension from a rectilinearity with a width of “0”, this expansion process being triggered by a user's input when the frame comes to a display state. The frame exhibiting the behavior attribute of frame scrolling, when becoming a non-display state, has its width gradually reduced down to the width of “0” from the predetermined frame width.

In the image processing system 1 according to this embodiment, a variety of user's inputs can be specified. Those user's inputs are, for example, an indication of displaying the original image, a click on the original image by a mouse, a click on the frame, or a selection of display/non-display of the frame from a pop-up menu.

The image and the text can be likewise inserted into the frame displayed by frame scrolling. The image and the text are displayed when the frame width comes to a predetermined value.

Further, the sound data can be also embedded into the frame exhibiting the behavior attribute of frame scrolling. In this case, the sound data embedded are outputted synchronizing with frame scrolling.

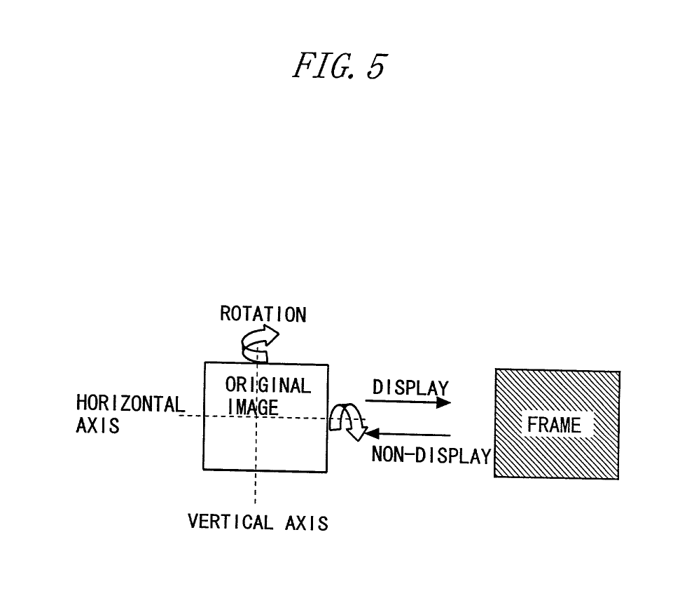

FIG. 5 shows an example of frame rotation. The frame rotation may be defined as a behavior attribute in which the original image is rotated about a vertical axis or a horizontal axis, this rotating process being triggered by the user's input. In the frame rotation, the frame is displayed as a rear side of the original image. In a state where the rear side of the original image is displayed, when the image processing system 1 further detects the user's input, a rotation of the rear side of the original image is triggered by this user's input, whereby the original image is displayed.

In the case of the frame rotation, the original image is rotated, and, when the rear side thereof is displayed, the text or image added is displayed.

Further, the sound data embedded beforehand are outputted synchronizing with the rotation of the original image from the front side to the rear side, or vice versa.

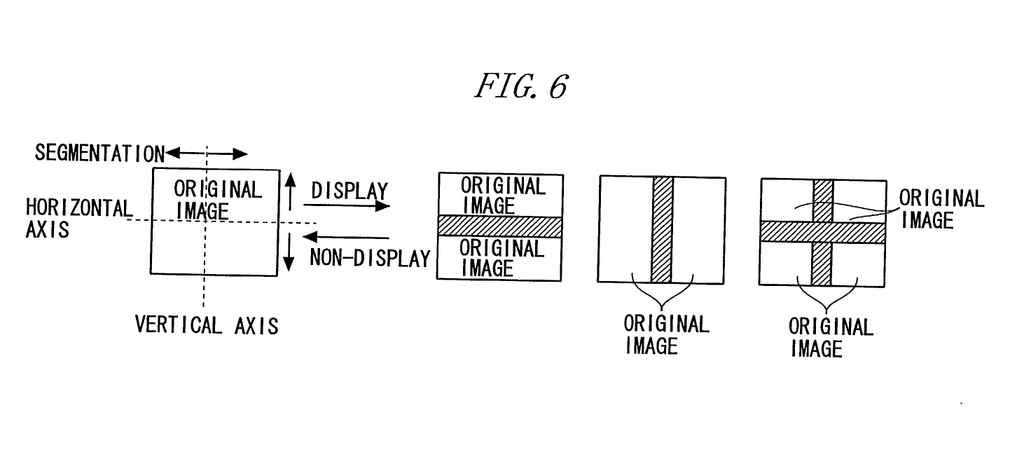

FIG. 6 shows an example of frame opening. Frame opening may be defined as a behavior attribute in which a line parallel to the vertical axis or the horizontal axis of the original image gradually thickens in its width with the user's input working as a trigger, and the frame is thus displayed. With this frame opening, an upper/lower/segmented frame, a right/left segmented frame or an upper/lower and right-/left segmented frame is displayed.

The frame displayed based on frame opening gradually decreases in its width with the user's input serving as a trigger, and comes to the non-display state.

In the same way as frame scrolling, the text or the image inserted into the frame displayed based on frame opening can be displayed, and the sound data embedded into the same frame can also be outputted.

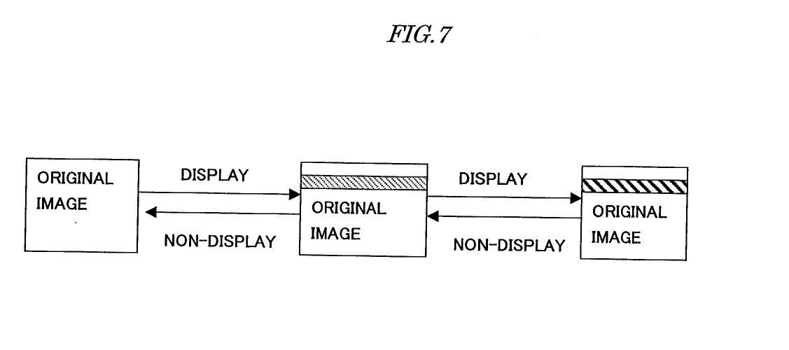

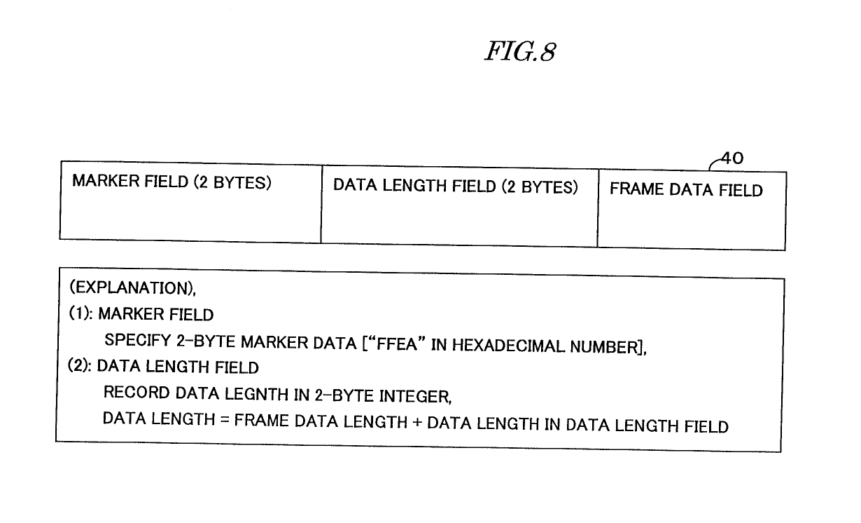

FIG. 7 shows an example of frame emerging. Frame emerging may be defined as a behavior attribute in which a frame color or a pixel density pattern (simply referred to as a pixel pattern) stepwise thickens with the user's input serving as a trigger, and the frame is thus displayed. According to frame emerging, a frame dimension such as a frame width etc does not change, however, there changes a density of the color or of the pixel pattern for expressing the frame.

The frame displayed based on frame emerging becomes gradually thin in color or pixel pattern with the user's input working as a trigger, and comes to the non-display state.

The image and the text can be similarly inserted into the frame displayed based on frame emerging. The image and the text are displayed synchronizing with a change in the density of the frame color or of the frame pixel pattern.

The sound data embedded into the frame are outputted synchronizing with frame emerging, i.e., the change in the density.

<Data Format>

FIGS. 8 through 16 each show a data format for recording the information added to the image object. Herein, an example of the data format of the information added to the image object described based on JPEG (Joint Photographic Experts Group) is explained.

The JPEG-based data format is prescribed in ISO (International Organization for Standardization) and CCITT (International Telephone and Telegraph Consultative Committee). The image processing system 1 adds the information to the image object by utilizing APPA (application marker) contained in the JPEG data. APPA corresponds to control data. Further an APPA part of the JPEG data corresponds to an invisible area. On the other hand, the image data of the original image corresponds to visible data.

FIG. 8 shows an outline of a data format of the application marker contained in the JPEG data. As illustrated in FIG. 8, the application marker processed by the image processing system 1 consists of a marker field, a data length field, and a frame data field 40.

The marker field has a 2-byte code (“FFEA” in hexadecimal number) representing the application marker.

The data length field has a data length obtained by adding a data length of the frame data field 40 to the data length (2 bytes) of the data length field itself.

The frame data field 40 retains the frame added by the image processing system 1, and data composed of the text, the image or the sound.

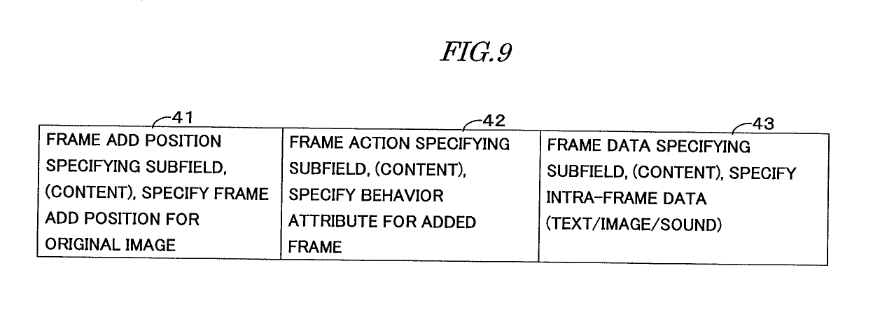

FIG. 9 shows a structure of the frame data field 40. As shown in FIG. 9, the frame data field 40 consists of a frame add position specifying subfield 41, a frame action specifying subfield 42 and a frame data specifying subfield 43.

A frame add position with respect to the original image is specified in the frame add position specifying subfield 41.

A behavior attribute with respect the added frame is specified in the frame action specifying subfield 42.

The intra-frame data (text/image/sound) are specified in the frame data specifying subfield 43.

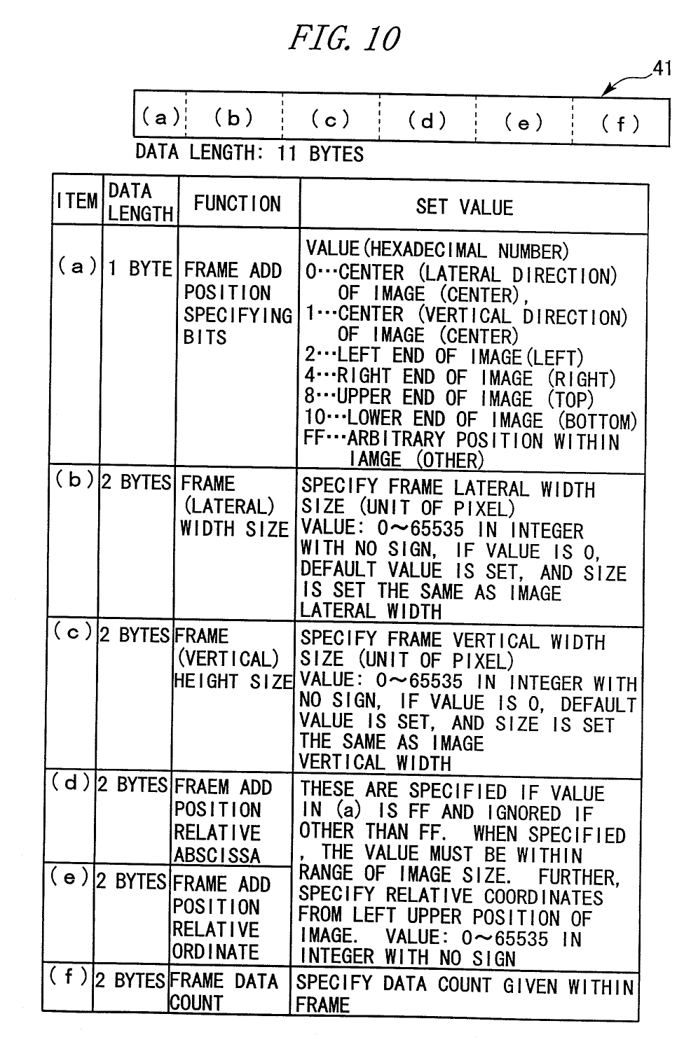

FIG. 10 shows the frame add position specifying subfield 41 in details. The frame add position specifying subfield 41 is composed of (a) frame add position specifying bits, (b) a frame (lateral) width size, (c) a frame (vertical) height size, (d) a frame add position relative abscissa, (e) a frame add position relative ordinate, and (f) a frame data count.

The frame add position specifying bits take each of values such as 0, 1, 2, 4, 8, O×10 (the prefix O× represents a hexadecimal number, and the following is the same) and O×FF. The frame add position specifying bits (a) take each of these values, and thereby retain a frame add position as indicated by each of set values in FIG. 10.

This frame add position specifying bits are a flag set in each bit position, and therefore a position can be specified by combining a plurality of flags. In this case, the frames are displayed in combination in the specified position. For example, when “6” is specified as the frame add position specifying bits, bits corresponding to 2 and 4 become ON, and hence the frames are added to the left and right sides of the original image.

The frame (lateral) width size (b) is stored with a frame lateral width size. If this value is “0”, however, a frame having the same size as the lateral width of the original image is generated as a default.

The frame (vertical) height size (c) is stored with a height of the frame, i.e., its width in the vertical direction.

The frame add position relative abscissa and the frame add position relative ordinate are effective when the frame add position specifying bits are O×FF (an intra-image arbitrary position). The frame add position relative abscissa (d) and the frame add position relative ordinate (e) are stored with positions to which the frames are added on the basis of relative coordinates in a coordinate system extending in a right downward direction, wherein an origin is set at a left upper position of the original image.

The frame data count (f) is stored with a data count (the number of pieces of sound data, text data or image data) specified within the frame. Accordingly, the image processing system 1 is capable of adding the plural pieces of data to the frame.

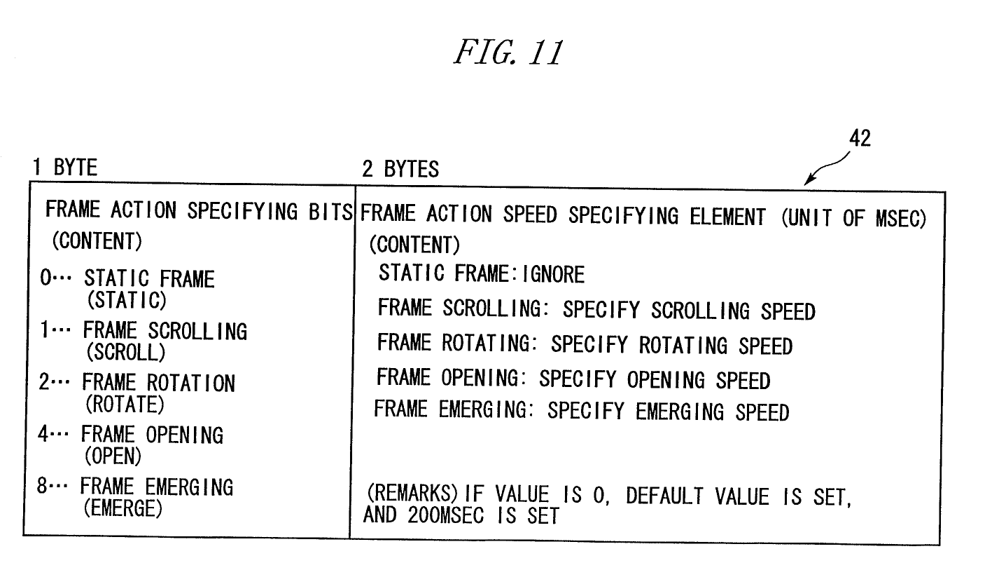

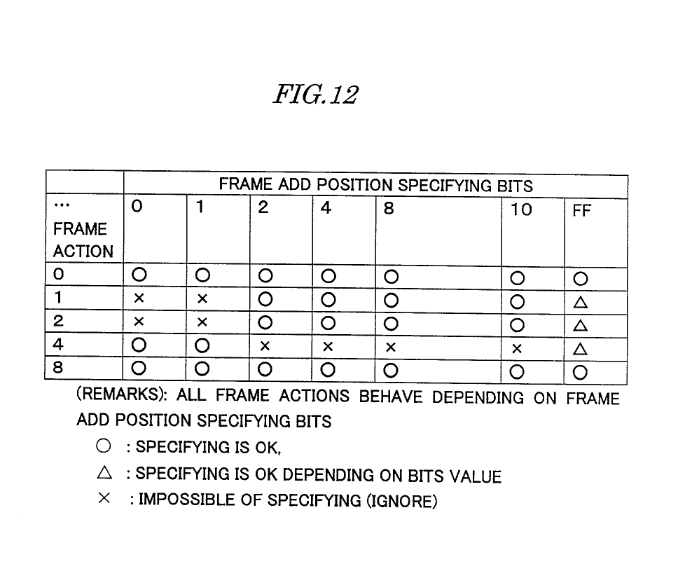

FIG. 11 shows details of the frame action specifying subfield 42. As shown in FIG. 11, the frame action specifying subfield 42 has data of 3 bytes on the whole. The frame action specifying subfield 42 consists of frame action specifying bits (1 byte) and a frame action speed specifying element (2 bytes).

The frame action specifying bits take (retains) a value for indicating a static frame, frame scrolling, frame rotation, frame opening or frame emerging.

The frame action speed specifying element is stored with a completion time of each action. In the case of the static frame, however, the frame action specifying element may be ignored.

FIG. 12 shows a relationship between the frame action and the frame add position in which the action can be specified. For example, the static frame (frame action=0) and frame emerging (frame action=8) are valid in all frame add positions.

On the other hand, the frame scrolling (frame action=1) and frame rotation (frame action=2) are invalid with respect to the frame (frame add position bit=0 or 1) added to the center of the original image.

Further, the frame opening (frame action=4) is invalid with respect to the frames (frame add position bits=2, 4, 8 and 10) added to the left, right, upper and lower positions of the original image.

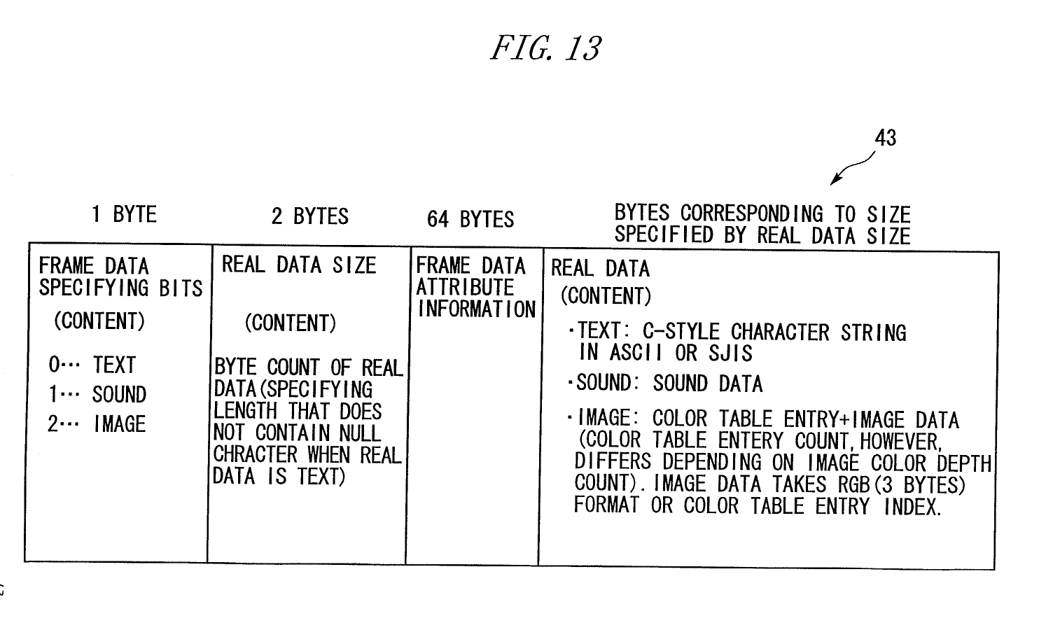

FIG. 13 shows a structure of the frame data specifying subfield 43. As shown in FIG. 13, the frame data specifying subfield 43 consists of frame data specifying bits (1 byte), a real data size (2 bytes), frame data attribute information (64 bytes) and real data.

The frame data specifying bits retain a category (text, sound or image) of the real data.

The frame data size has a byte count of the real data. This byte count does not contain the number of NULL characters. The NULL character may be defined as a character code that represents a tail of string of characters configuring the text.

A content of the frame data attribute information differs depending on the category of the real data.

The real data retain the text and the image displayed within the frame, or the sound to be reproduced.

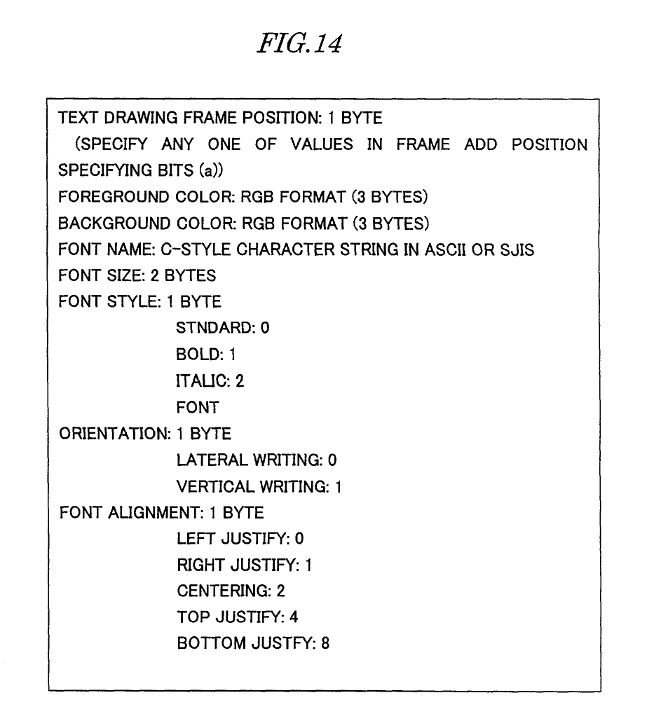

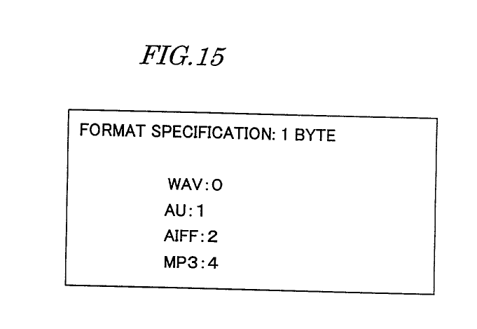

FIG. 14 shows a structure of the frame data attribute information when the real data are categorized as the text data. The frame data attribute information about the text contains a frame position where text is drwan, a foreground color, a background color, a font name, a font size, a font style, a font orientation and font alignment, which are used for expressing the text.

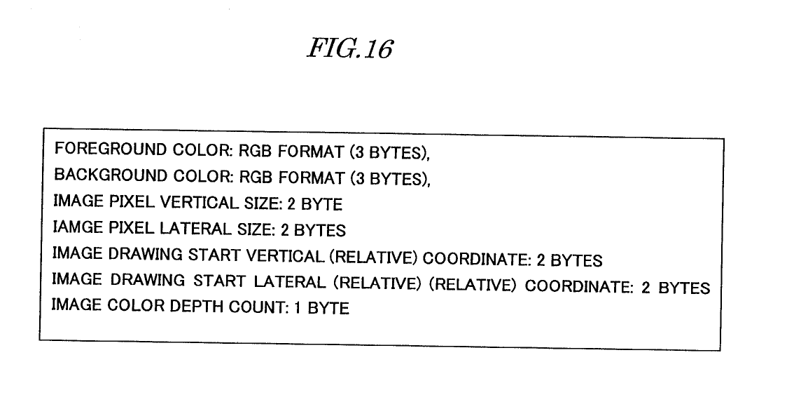

FIG. 15 shows frame data attribute information when the real data are categorized as the sound data. In this case, the frame data attribute information retains a format specification (WAV, AU, AIFF, MP3 (MPEG-1 Audio Layer-III)) of the sound data.

FIG. 16 shows a structure of the frame data attribute information when the real data are categorized as the image data. The frame data attribute information with respect to the image contains a foreground color, a background color, a pixel size of the image (held as the real data), drawing start coordinates, and an image color depth.

<Hardware Architecture of Image Processing System 1>

FIG. 17 is a diagram showing a hardware architecture of the image processing system 1. Referring to FIG. 1, the image processing system 1 includes a CPU (Central Processing Unit corresponding to a control unit) 2, a ROM (Read Only Memory) 3, a RAM (Random Access Memory) 4a hard disk drive (HDD including a hard disk) 5, a floppy disk drive (a FDD) 6, a CD-ROM drive 7, a graphic board 8, a communication control device 9, an interface circuits (I/F) 10, 11, 20. Th HDD 5 and the FDD 6 correspond to a recording unit.

A display 13 such as cathode ray tube (CRT), a liquid crystal display (LCD) etc is connected to the graphic board 8. A key board (KBD) 14 is connected to the interface circuit I/F10. A pointing device 15 such as a mouse, a track ball, a flat space, a joystick etc is connected to the interface I/F11. A loud speaker 19 is connected to the interface I/F20.

The ROM 3 is stored with a boot program. The boot program is executed by the CPU 2 when switching ON a power source of the image processing system 1. An operating system (OS) and a single or a plurality of drivers for display processes or communication processes, which are stored in the HDD 5, are loaded into the RAM 4. A variety of processes and control can be thereby executed.

A program for controlling the image processing system 1 is developed on the RAM 4. Further, the RAM 4 is stored with a result of processing based on this program, temporary data for processing, and display data for displaying a processing result in the screen of the display 13. Then, the RAM 4 is used as an operation area for the CPU 2.

The display data developed on the RAM 4 are transferred via the graphic board 8 to the display 13. A display content (text, image etc) corresponding to the display data is displayed on the screen of the display 13.

The HDD 5 is a device for recording or reading a program, control data, text data, image data etc, on or from the hard disk in accordance with a command given from the CPU 2.

The FDD 5 executes reading or writing the program, control data, text data, image data etc, from or to the floppy disk (FD 17 in accordance with a command given from the CPU 2.

The CD-ROM drive 7 reads the program and the data recorded on the CD-ROM (Read Only Memory using a compact disk) 18 in accordance with a command given from the CPU 2.

The communication control device 9 transmits and receives the data to and from other devices by using communication lines connected to the image processing system 1, or executes uploading or downloading the program and the data in accordance with a command issued from the CPU 2.

The KBD 14 has a plurality of keys (character input keys, cursor key etc) and is used for an operator to input the data to the image processing system 1. The pointing device 15 is used for inputting an indication given by the cursor displayed on the display 13.

The CPU 2 executes a variety of programs stored in the ROM 3, HDD 5, FD 17 and CD-ROM 18, which each correspond to a recording medium according to the present invention. The CPU 2 gives an indication to each of the components within the image processing system 1, and controls the operations of the image processing system 1 and of the peripheral devices 13˜19 thereof.

The CPU 2 thereby controls the image processing system 1 of the present invention. The image processing system 1 provides image object processing function.

Note that the programs and data described above may be stored beforehand on the recording medium such as the HDD 5 etc, or may be downloaded from other system and stored on the recording medium.

<Configuration of Operation Screen>

FIG. 18 shows an operation screen of the image processing system 1. This operation screen is configured by (upper and lower) box areas containing a menu bar, and a drawing area 45, defined by these box areas, for displaying an image.

Pull-down menus such as “File”, “Edit”, “display”, “Insert”, “format” and “help” are displayed in the menu bar.

The user selects a processing target or display target image object (i.e., the image data file in the JPEG format) by use of the pull-down menu “file”. The image object selected is displayed in the drawing area 45. Thus, it corresponds to specifying image object as a processing target to specify the already-created image object as a processing target.

Further, the user is able to add the frame to the image object being displayed by use of the pull-down menu “Edit”. When adding the frame, the frame add position is specified in the frame add position specifying subfield shown in FIG. 10, and the data about the frame action is specified in the frame action specifying subfield 42 shown in FIG. 11.

Moreover, the user is able to insert a text or other image to be displayed into the added frame by use of the pull-down menu “Insert”. When inserting the text and other image, the frame data attribute information shown in FIG. 13-FIG. 16 is specified.

Further, the user is able to specify a file of the sound data to be reproduced together with displaying the image by use of the pull-down menu “Insert”. On this occasion, the sound data format shown in FIG. 15 is specified.

<Example of Frame Add Operation>

FIG. 19 shows an example of the operation of adding the frame to the image object.

The user, to start with, selects a file stored with the original image by use of the pull-down menu “File”. Then, the image processing system 1 displays an original image 46 in the drawing area 45 shown in FIG. 18.

Next, the user defines a frame to be added to the original image 46 by use of the pull-down menu “Edit”.

Elements specified in the operation illustrated in FIG. 19 are the add position: 8 (a lower end of the image, which may be called “BOTTOM”), the frame lateral size: 0 (the same size as the lateral width of the original image), the frame vertical size: 32, the action: 0 (static) and so on. A frame 47a is thereby added to the BOTTOM of the image as seen in the image object 47.

Next, the user specifies the text to be displayed on the frame by use of the pull-down menu “Insert”. In the example shown in FIG. 19, the text data “Photo of Swan” is specified such as the foreground color: O×FFFFFF (black), the background color: O×OOOOOO (white), the font name: Mincho style, the font size: 8 and so forth. The text data “Photo of Swan” is displayed in a frame 48a as seen in the image object 48.

Next, the user stores the image object 48 added with the frame 48a in the file in the JPEG format by use of the pull-down menu “File”.

<Function and Effect>

FIGS. 20 through 24 are flowcharts showing processing steps of the program executed by the CPU 2 of the image processing system 1.

FIG. 20 shows steps of a data coding process. This data coding process is executed when the image object edited on the operation screen in FIG. 18 is stored in the JPEG formatted file. This process is basically the same as the JPEG formatted file creating process.

In the data coding process, at first, the CPU 2 writes an SOI (Start Of Image) marker to the head of the file (S1).

Next, the CPU 2 writes an application marker (APPO) (S2).

Subsequently, the CPU 2 writes an application marker (APPA) (S3). In the process of writing APPA, the text, the sound or the image is added to the frame described above. On this occasion, the CPU 2 assembles the frame data field 40 shown in FIGS. 9 through 17 in accordance with the information specified by the user, and eventually writes a content of the frame data field 40 to the file in the data format in the APPA marker field in FIG. 8.

Next, the CPU 2 writes a quantization segment (DQT) (S4).

Subsequently, the CPU 2 writes an SOF (Start Of Frame) marker (S5).

Next, the CPU 2 writes a Huffman table segment (DHT) (S6).

Subsequently, the CPU 2 writes an SOS (Start Of Scan) marker (S7).

Next, the CPU 2 encodes the image data on MCU (Minimum code Unit) and writes the coded image data to the file (S8).

Next, the CPU 2 writes an EOI (End Of Image) marker (S9). Thereafter, the CPU 2 finishes the data coding process.

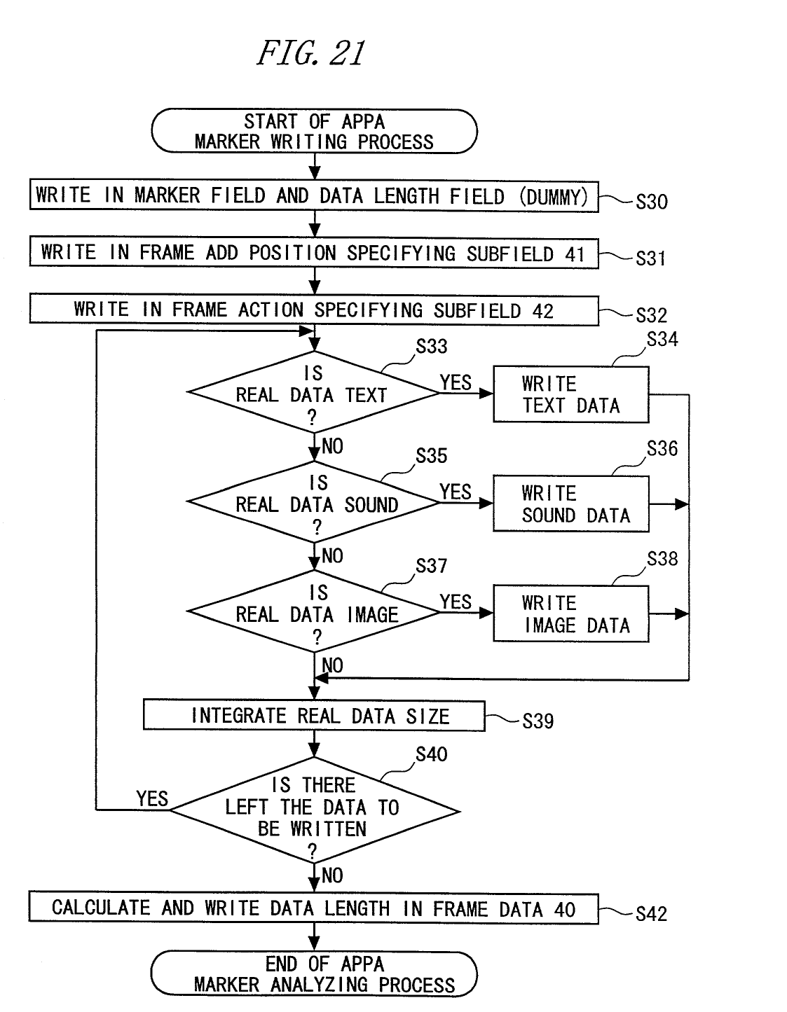

FIG. 21 shows details of an application marker (APPA) writing process. In this process, at first, the CPU 2 writes contents of the marker field and of the data length field shown in FIG. 8 to the file (S30). At this point of this, however, a value in the data length field is unknown, and hence the CPU 2 writes a dummy data length (2 bytes).

Next, the CPU 2 creates a content in the frame add position specifying subfield 41 shown in FIGS. 9 and 10, and writes the content thereof to the file (S31).

Subsequently, the CPU 2 creates a content in the frame action specifying subfield 42 shown in FIGS. 9 and 11, and writes the content thereof to the file (S32).

Next, the CPU 2 creates a content in the frame data specifying subfield 43 shown in FIG. 9 or FIG. 13, and writes the content thereof to the file. The frame data specifying subfield 43, however, takes a data format that differs depending on which category the real data comes under, the text data or the sound data or the image data.

Then, the CPU 2 next judges based on the specification by the user whether the data to be written is the text data or not (S33). If the data to be written is the text data, the CPU 2 creates the content in the frame data specifying subfield 43 shown in FIG. 13 in a text data format, and writes the text data to the file (S34).

Whereas if the data to be written is not the text data, the CPU 2 judges whether or not the data to be written is the sound data (S35). If the data to be written is the sound data, the CPU 2 creates the content in the frame data specifying subfield 43 shown in FIG. 13 in a sound data format, and writes the sound data to the file (S36)

Whereas if the data to be written is not the sound data, the CPU 2 judges whether or not the data to be written is the image data (S37). If the data to be written is the image data, the CPU 2 creates the content in the frame data specifying subfield 43 shown in FIG. 13 in an image data format, and writes the image data to the file (S38).

Next, the CPU 2 integrates sizes of the respective sets of data (real data) written to the file in the processes in S33 through S38 (S39).

Next, the CPU 2 judges whether or not the there is left the data to be written (S40). If the data is left, the CPU 2 returns the control to the process in S33, and repeats executing the same processes.

If it is judged in S40 that there is no data to be written, the CPU 2 calculates a data length in the whole frame data field from the integrated value of the present data size. Then, the CPU 2 writes an actual data length in the field where the dummy data length has been written in the process in S30 (S42).

Thereafter, the CPU 2 finishes the APPA marker writing process (S21).

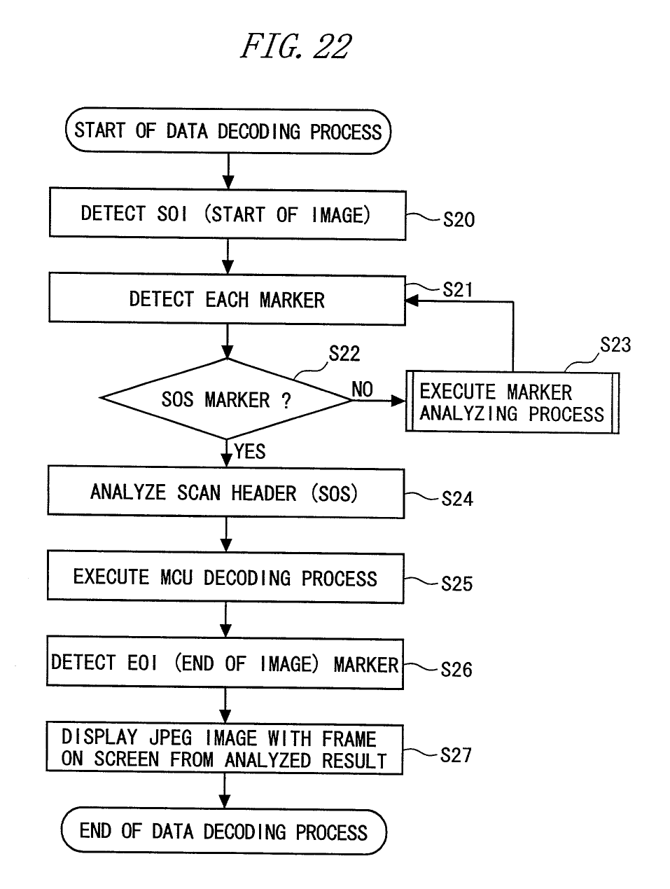

FIG. 22 shows a data decoding process in detail. When the image object is displayed in the drawing area 45 in FIG. 18, this data decoding process is executed.

This process is basically involves reversal steps to the data coding process shown in FIG. 20. To begin with, the CPU 2 detects the SOI (Start Of Image) in the head of the file (S20).

Next, the CPU 2 detects each of the markers (S21). If the marker is ruled out of the SOS marker (No judgement in S22), the CPU 2 advances the control to a marker analyzing process (S23). In this process, the information (the frame and the text or sound or image) added in the coding process in FIG. 20 is decoded in the analysis of the application marker (APPA).

While on the other hand, if the marker is detected to be the SOS marker, the CPU 2 analyzes a scan header (SOS) (S24). The scan header indicates a start of the image data stored in the JPEG file. According to JPEG, the scan header is set at the tail of each marker, and therefore the CPU 2 eventually advances the control to S24.

Next, the CPU 2 decodes the image data written based on MCU (S25).

Subsequently, the CPU 2 detects the EOI (End Of Image) marker (S26).

Next, the CPU 2 displays the frame-added JPEG data in the drawing area 45 in FIG. 18 (S27). Thereafter, the CPU 2 comes to an end of the data decoding process.

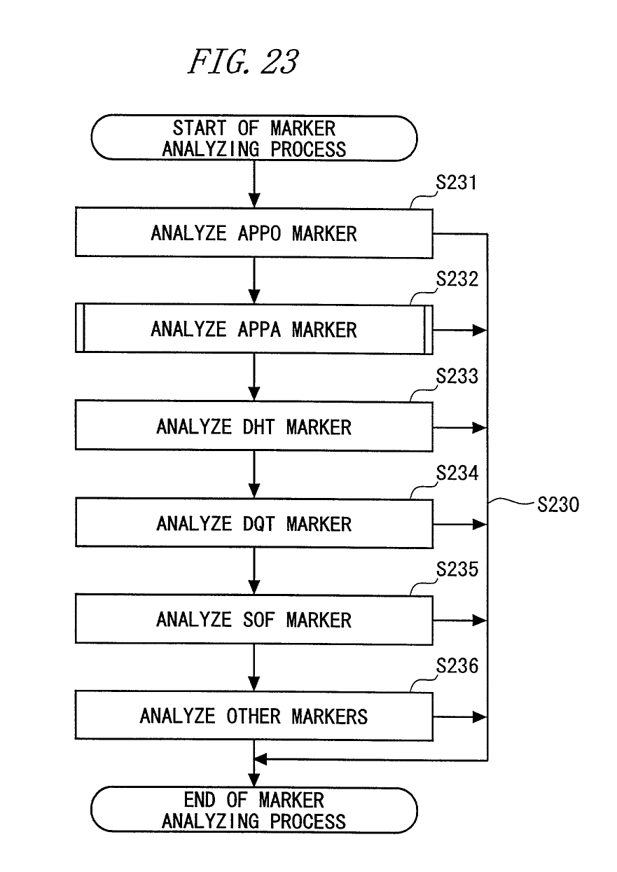

FIG. 23 shows the marker analyzing process of each marker in details.

At first, the CPU 2 confirms whether or not the marker being processed at present is the application marker (APPO). If the marker being processed at present is the application marker (APPO), the CPU 2 analyzes this marker (S231). Thereafter, the CPU 2 finishes the marker analyzing process (step line S230).

If the marker being processed at present is not the application marker (APPO), the CPU 2 confirms whether or not this marker is an application marker (APPA). If the marker being processed at present is the application marker (APPA), the CPU 2 analyzes this marker. From this analysis, the CPU2 recognizes the information added to the image object (S232). Thereafter, the CPU 2 finishes the marker analyzing process (step line S230).

If the marker being processed at present is not the application marker (APPA), the CPU 2 confirms whether or not this marker is the Huffman table segment (DHT). If the marker being processed at present is the Huffman table segment, the CPU 2 reads the Huffman table segment (S233). Thereafter, the CPU 2 finishes the marker analyzing process (step line S230).

If the marker being processed at present is not the Huffman table segment, the CPU 2 confirms whether or not this marker is the quantization segment (DQT). If the marker being processed at present is the quantization segment, the CPU 2 reads a quantization table (S234). Thereafter, the CPU 2 finishes the marker analyzing process (step line S230).

If the marker being processed at present is not the quantization segment, the CPU 2 confirms whether or not this marker is SOF (Start Of Frame). If the marker being processed at present is SOF, the CPU 2 recognizes the head of the frame (S235). Thereafter, the CPU 2 finishes the marker analyzing process (step line S230).

If the marker being processed at present is not SOF, the CPU 2 analyzes other marker (S236), however, its explanation is omitted herein. Thereafter, the CPU 2 finishes the marker analyzing process (step line S230).

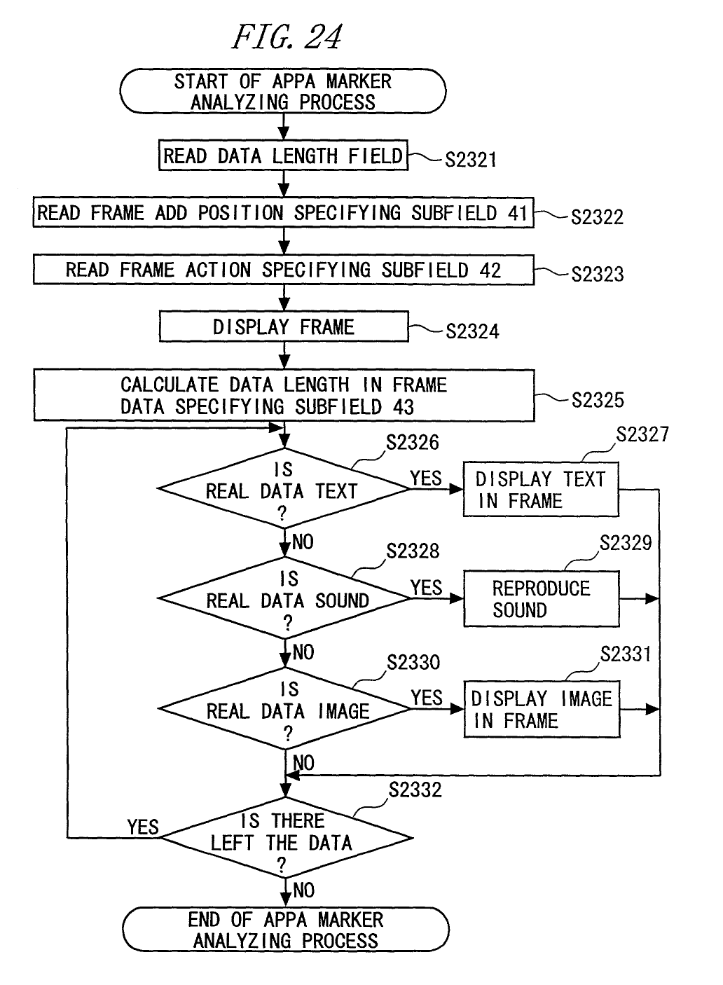

FIG. 24 shows an application marker (APPA) analyzing process in details. When the CPU 2 detects the marker field (“FFEA”) of the APPA marker, this process is executed.

At first, the CPU 2 reads a value in the data length field (S3231). This is because the CPU 2 confirms from the value in the data length field whether or not all the APPA markers have been analyzed.

Next, the CPU 2 reads the contents in the frame add position specifying subfield 41 (S2322). The CPU 2 thereby obtains a frame add position, a frame width, a frame height, frame add position relative coordinates and a frame data count shown in FIG. 10.

Subsequently, the CPU 2 reads the content in the frame action specifying subfield 42 (S2323). With this process, the CPU 2 recognizes the frame action shown in FIG. 11.

Next, the CPU 2 displays the frame (S2324) and calculates the data length of frame data specifying subfield 43 (S3235). Then it reads the contents in the frame data specifying subfield 43 with repetitions corresponding to the frame data count. As already explained in the APPA marker writing process (FIG. 21), the frame data specifying subfield 43 takes the data format that differs depending on which category the data comes under, the text data or the sound data or the image data.

Such being the case, the CPU 2 checks 3 bytes at the head of the frame data specifying subfield 43, thereby judging the category f the data (real data) stored in the frame data specifying subfield, and the real data size as well.

To be more specific, the CPU 2 at first judges whether the real data is the text data or not (S2326). If the real data is categorized as the text data, the CPU 2 reads the text data corresponding to the real data size, and displays the text in the frame (S2327).

Whereas if the real data is not the text data, the CPU 2 judges whether the real data is the sound data or not (S2328). If the real data is categorized as the sound data, the CPU 2 reads the sound data corresponding to the real data size, and reproduces the sound data (S2329).

Whereas if the real data is not the sound data, the CPU 2 judges whether the real data is the image data or not (S2330). If the real data is categorized as the image data, the CPU 2 reads the image data corresponding to the real data size, and displays the image in the frame (S2331).

Next, the CPU 2 judges whether or not there is left the data (S2332). If the data still remains in the frame specifying subfield 43, the CPU 2 returns the control to S2326 and repeats executing the same processes.

Whereas if no data is left in the frame specifying subfield 43, the CPU 2 finishes the APPA marker analyzing process. At this time, it is confirmed whether or not the data corresponding to the data length read in S2321 have been processed.

As discussed above, the image processing system 1 in this embodiment is capable of adding the frame to the image object, and hence the image object can be appreciated with the same feeling as seeing a photo taken by a camera using the normal film.

Further, the present image processing system 1 is, in the frame adding process, capable of adding the frames to the upper, lower, left and right sides of the image object and to arbitrary positions within the image object area, and is therefore capable of giving a variety of changes to the image object.

Further, the present image processing system 1 is capable of defining the frame by specifying the frame action when displaying the added frame. Hence, the variety of changes can be added to the display of the image object.

Moreover, the present image processing system 1 is capable of embedding the text data, sound data or image data into the frame to be added to the image object. It is therefore feasible to save batchwise the information related to the image object, e.g., a caption for briefing the image object, an image object generated (photographed) date or sounds when generating the same object.

Further, the present image processing system 1 is capable of storing the above frames, and the text data, sound data and image data saved together with the frames, in the area different from the area stored with the original image data itself of the image object, for instance within the JPEG application marker (APPA). Therefore, no alternation is added to the original image object. Namely, the frame, and the text data, sound data and image data saved together with the frame, can be removably added to the image object.

Further, according to the present image processing system 1, the information is added to the JPEG application marker (APPA), and hence no influence is exerted on the application program that does not recognize the application marker (APPA). That is, a data compatibility of the image object can be maintained even when the information is added to the image object. Hence, the image object added with such pieces of information is normally treated as a general JPEG file.

<Modification of Processing Target Image Object>

The already-created image object is specified as the processing target in the embodiment discussed above. The processing target in this embodiment is not, however, limited to the image object described above. For example, a new image object is created by use of image creation software, and the information may also be added this new image object. Thus, this scheme of creating the new image object and setting it as a processing target also falls within the concept of specifying the image object as the processing target.

The new image object may be created on an operation screen in FIG. 18 or on other operation screen, and the information may be added intact to this object.

<Modification of Image File Format>

This embodiment has involved the use of JPEG format as the image file format. The embodiment of the present invention is not, however restricted to the image file format. Namely, the present invention can be embodied with respect to the general image files in which the user definition information corresponding to the application markers are usable.

<Readable-by-Computer Recording Medium>

The program demonstrated in this embodiment may be recorded on a readable-by-computer recording medium. Then, the computer reads and executes the program on this recording medium, thereby functioning as the image processing system 1 demonstrated in this embodiment.

Herein, the readable-by-computer recording medium embraces recording mediums capable of storing information such as data, programs, etc. electrically, magnetically, optically and mechanically or by chemical action, which can be all read by the computer. What is demountable out of the computer among those recording mediums may be, e.g., a floppy disk, a magneto-optic disk, a CD-ROM, a CD-R/W, a DVD, a DAT, an 8 mm tape, a memory card, etc.

Further, a hard disk, a ROM (Read Only Memory) and so on are classified as fixed type recording mediums within the computer.

<Data Communication Signal Embodied in Carrier Wave>

Furthermore, the program describe above may be stored in the hard disk and the memory of the computer, and downloaded to other computers via communication media. In this case, the program is transmitted as data communication signals embodied in carrier waves via the communication media. Then, the computer downloaded with this program can be made to function as the image processing system 1 in this embodiment.

Herein, the communication medium may be any one of cable communication mediums (such as metallic cables including a coaxial cable and a twisted pair cable, or an optical communication cable), and wireless communication media (such as satellite communications, ground wave wireless communications, etc.).

Further, the carrier waves are electromagnetic waves for modulating the data communication signals, or the light. The carrier waves may be DC signals (in this case, the data communication signal takes a base band waveform with no carrier wave). Accordingly, the data communication signal embodied in the carrier wave may be any one of a modulated broadband waveform and a signal taking an unmodulated base band signal and an unmodulated base band signal (corresponding to a case setting a DC signal having a voltage of 0 as a carrier wave).

What is claimed is:

1. An image processing system comprising:
a control unit having an image object specified as a processing target and having add information specified that decorates said image object,
wherein said control unit adds, to said image object, the add information treatable as an integral component with said image object in a state that does not alter a content of said image object itself.

2. An image processing system according to claim 1, wherein the add information is a frame removably addable to said image object.

3. An image processing system according to claim 1, wherein the add information configures a part of said image object in an added state.

4. An image processing system according to claim 1, wherein the add information has at least one of a sound attribute, a text attribute and a behavior attribute together with an image attribute for configuring a part of said image object.

5. An image processing system according to claim 4, wherein the image attribute of the add information is displayed, the sound attribute thereof is reproduced, the text attribute thereof is displayed, or the behavior attribute is executed in linkage with an operation through said control unit.

6. An image processing system according to claim l, further comprising a recording unit recording the add information as a single file together with said image object.

7. An image processing system for displaying an image object in a display area, comprising:
a unit detecting said image object recorded in a file, and control data contained in said image object, said control data indicating add information; and
a unit decorating said image object by use of said add information indicated by the control data detected, and displaying said decorated image object in said display area.

8. An image object processing method comprising:
specifying an image object as a processing target;
specifying add information to be added to said image object; and
adding, to said image object, the add information treatable as an integral component with said image object in a state that does not alter a content of said image object itself.

9. An image object processing method according to claim 8, wherein the add information is a frame removably addable to said image object.

10. An image object processing method according to claim 8, wherein the add information configures a part of said image object in an added state.

11. An image object processing method according to claim 10, wherein the add information has at least one of a sound attribute, a text attribute and a behavior attribute together with an image attribute for configuring a part of said image object.

12. An image object processing method according to claim 11, further comprising detecting an operation with respect to said image object,
wherein the image attribute of the add information is displayed, the sound attribute thereof is reproduced, the text attribute thereof is displayed, or the behavior attribute is executed in linkage with this operation.

13. An image object processing method according to claim 8, further comprising recording said image object in a file, wherein the add information is structured as a single file together with said image object.

14. An image object processing method comprising:
detecting an image object recorded in a file, and control data contained in said image object, said control data indicating add information; and
decorating said image object by use of said add information indicated by the control data detected, and displaying said decorated image object in a display area.

15. An image object processing method comprising:
specifying a frame treated as an integral component with an image object;
registering at least one of an image attribute, a sound attribute, a text attribute and an behavior attribute in the frame;
displaying said image object added with the frame;
reproducing the sound attribute, displaying the text attribute, displaying the image attribute or executing the behavior attribute when said image object or the frame displayed is operated; and
recording said image object and the frame as an integral file.

16. A storage medium readable by a machine, tangible embodying a program of instructions executable by the machine to perform method steps for processing an image object, the method steps comprising:
specifying an image object as a processing target;
specifying add information to be added to said image object; and
adding, to said image object, the add information treatable as an integral component with said image object in a state that does not alter a content of said image object itself.

17. A storage medium readable by a machine tangible embodying a program according to claim 16, of instructions executable by the machine, wherein the add information is a frame removably addable to said image object.

18. A storage medium readable by a machine tangible embodying a program according to claim 16, of instructions executable by the machine, wherein the add information configures a part of said image object in an added state.

19. A storage medium readable by a machine tangible embodying a program according to claim 18, of instructions executable by the machine, wherein the add information has at least one of a sound attribute, a text attribute and a behavior attribute together with an image attribute for configuring a part of said image object.

20. A storage medium readable by a machine tangible embodying a program according to claim 19, of instructions executable by the machine, further comprising a step of detecting an operation with respect to said image object,
wherein the image attribute of the add information is displayed, the sound attribute thereof is reproduced, the text attribute thereof is displayed, or the behavior attribute is executed in linkage with this operation.

21. A storage medium readable by a machine tangible embodying a program according to claim 16, of instructions executable by the machine, further comprising recording said image object in a file, wherein the add information is structured as a single file together with said image object.

22. A storage medium readable by a machine, tangible embodying a program of instructions executable by the machine to perform method steps for processing an image object, the method steps comprising:
detecting an image object recorded in a file, control data contained in said image object and indicating add information;
decorating said image object by use of said add information indicated by said control data detected; and
displaying said decorated image object in a display area.

23. A storage medium readable by a machine, tangible embodying a program of instructions executable by the machine to perform method steps for processing an image object, the method steps comprising:
specifying a frame treated as an integral component with an image object;
registering at least one of an image attribute, a sound attribute, a text attribute and an behavior attribute in the frame;
displaying said image object added with the frame;
reproducing the sound attribute, displaying the text attribute, displaying the image attribute or executing the behavior attribute when said image object or the frame displayed is operated; and
recording said image object and the frame as an integral file.

24. An image processing system according to claim 1, wherein said control unit adds control data for indicating the add information to an invisible area in said image object.

25. An image object processing method according to claim 8, further comprising adding the control data for indicating the add information to an invisible area in said image object.

26. A storage medium readable by a machine tangible embodying a program according to claim 16, of instructions executable by the machine, further comprising adding the control data for indicating the add information to an invisible area in said image object.

27. A readable-by-computer recording medium recorded with an image object comprising:
visible data; and
control data for said image object,
wherein said control data indicates add information for decorating said visible data, and is used when said visible data is displayed in a display area.
